(19) United States
(12) Patent Application Publication
(10) Pub. No.: US 2017/0005954 A1
(43) Pub. Date: Jan. 5, 2017

(54) SYSTEM AND METHOD FOR COMMUNICATION MANAGEMENT THROUGH ANALYSIS OF RECIPIENT BEHAVIOR AND/OR CONTACT RELATIONSHIPS

(71) Applicant: VONAGE NETWORK LLC, Holmdel, NJ (US)

(72) Inventors: Natan Shaltiel, Tel-Aviv (IL); Matthew Dennis Krokosz, Wall, NJ (US); Yuval Golan, Rishon Le-zion (IL)

(21) Appl. No.: 14/754,837

(22) Filed: Jun. 30, 2015

(51) Int. Cl. H04L 12/58; H04L 29/08; H04W 68/00

(52) U.S. Cl. CPC H04L 51/02; H04L 51/26; H04W 68/005; H04L 67/22

(57) ABSTRACT

Systems and methods for aiding communication terminal users in the management of incoming call and/or message arrival notifications. In an embodiment, a method comprises receiving a notification associated with an invitation to establish a communication session between a communication originator and an intended recipient or to the availability, for retrieval and/or access, of a voice, text, or e-mail message. The notification is processed based on a passively derived classification or score assigned to the communication originator. A passively derived classification or score is one which does not depend upon the recipient of any prior communication to identify and/or characterize the originator of the prior communication. In some embodiments, delivery of a message and/or an invitation to communicate is automatically blocked or accepted based on the classification. In other embodiments, an enhanced notification is generated and forwarded to a communication terminal associated with the intended recipient.

### BACKGROUND

Field

Embodiments of the present invention generally relate to the treatment of communications addressed to one or more recipients and, more particularly, to systems and methods which facilitate differentiated treatment of communication availability notifications based, at least in part, on at least one of an identity, association, or characteristic of the originator of the associated communication.

Description of the Related Art

The volume of communications arriving at a recipient's communication terminal can be unpredictable and, at times, overwhelming. A single recipient may receive hundreds of phone calls, text messages, and/or voice or e-mail messages (inclusive of speech-to-text e-mail messages or text to speech voice mail messages in a unified communication system) on any given day. In some cases, the recipient receives, over a network or peer-to-peer communication link, notifications of arrival and/or availability by which he or she is able to identify the originator of an incoming phone call, text and/or voice message. By way of example, a notification as received from a communication server (or some other network element) may include a network address which the recipient already associates with a particular person or entity (e.g., a telephone number displayed via Caller ID, an e-mail address, or the like). Alternatively, the notification convey information such, for example, as an IP address from which an identity or characteristic of the originator can be determined by reference to some other source.

Where a communication arrival or availability notification comprises a familiar network address or source identifier, the person to whom the corresponding communication is addressed (i.e., the “intended recipient”) may be able to quickly and accurately decide the relative importance of the arriving notification relative to other activities in which he or she may be engaged. For notifications associated with unfamiliar originators, however, an intended recipient risks missing an opportunity to act upon time sensitive or otherwise critical information if he or she decides not to respond immediately by answering the associated call or by reviewing a received voice, text or e-mail message in its entirety. As a result, an intended recipient choosing not to take that risk may waste valuable time by, for example, preferentially allocating time to accepting unimportant (e.g., telemarketer) calls or review spam messaging content at the expense of more critical business functions.

For those communications originating from an unfamiliar source, a lack of effective techniques and systems for differentiating between those communications likely to be of importance to a recipient and those communications likely to be of no significance or interest to a recipient can be stressful to the recipient and result in less efficient usage of telephony, voice messaging, and e-mail communication applications as business tools.

A need therefore exists for configurable, dynamically adaptive, and user friendly techniques for facilitating differential treatment of communication notifications.

### SUMMARY

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Systems and methods are described for aiding in the management of communication arrival and/or availability notifications corresponding, for example, to incoming phone calls and/or e-mail messages, voice mail messages, text messages and/or other forms of communication. According to one or more embodiments, a method comprises receiving, over a communication medium, a notification associated with at least one of an invitation to establish a communication session between a communication originator and an intended recipient or a message from the communication originator available for retrieval and/or access by the intended recipient; and processing the received notification based on a passively derived classification of the communication originator.

According to embodiments of the present disclosure, a passively derived classification is one which does not depend upon the recipient of a communication to identify and/or characterize a communication originator. In some embodiments, for example, the classification is passively derived by statistically analyzing prior interactions between the communication originator and at least some of a plurality of communication terminal users. In other embodiments, the classification is passively derived by determining a degree of adjacency between the communication originator and at least one contact stored in a contact directory associated with the intended recipient.

In another embodiment, an apparatus comprises a computer having one or more processors, memory and at least one network interface. The apparatus includes a transceiver for receiving, over a communication medium, a notification associated with at least one of an invitation to establish a communication session between a communication originator and an intended recipient or a message from the communication originator available for retrieval and/or access by the intended recipient. The apparatus further includes a communication differentiation module which comprises instructions stored in memory and executable by the one or more processors. The communication differentiation module acts on the incoming communication notification based on a passively derived classification of the communication originator. The communication differentiation module may, for example, block the incoming communication notification, or it may generate an enhanced communication message.

In yet another embodiment, a computer readable medium comprises instructions that, when executed by a processor, cause a system to receive, over a communication medium, a notification associated with at least one of an invitation to establish a communication session between a communication originator and an intended recipient or a message from the communication originator available for retrieval and/or access by the intended recipient; and to at least one of block the received notification or to generate an enhanced notification based on a passively classification of the communication originator. In some embodiments, the classification is derived from at least one of prior interactions between the communication originator and at least some of a plurality of communication terminal users, or a degree of adjacency between the communication originator and at least one contact stored in a contact directory associated with the intended recipient.

### BRIEF DESCRIPTION OF THE DRAWINGS

FIG. 1A is a block diagram depicting a communication system configured to aid in the administration of communication notifications associated with requests to establish a communication session and/or with the arrival or availability of e-mail, voice mail, and/or text messages, according to one or more network centric embodiments;

FIG. 1B is a block diagram depicting a communication system configured to aid in the administration of communication notifications associated with requests to establish a communication session and/or with the arrival or availability of e-mail, voice mail, and/or text messages, according to one or more communication terminal (e.g., “endpoint”) centric embodiments;

FIG. 2 is a block diagram depicting, in greater detail, the interaction between the functional components according to embodiments exemplified by FIG. 1A;

FIG. 3 is a flow diagram depicting a method for aiding recipients in the administration of communication notifications, according to one or more embodiments;

FIG. 4 is a flow diagram depicting a method for determining a passively derived classification of a communication originator as, for example, a sub-process of the method of FIG. 3, according to one or more embodiments;

FIG. 5 is a flow diagram depicting a network centric method for processing, based on the passively derived classification, a communication notification and/or an arriving invitation or message availability notification associated with the notifications as, for example, a sub-process of the method of FIG. 3, according to one or more embodiments;

FIG. 6 is a flow diagram depicting a communication terminal centric method for processing, based on the passively derived classification, a communication notification and/or an arriving invitation or message availability notification associated with the notifications as, for example, a sub-process of the method of FIG. 3, according to one or more embodiments;

FIG. 7A is a tabular representation depicting the treatment given, by an exemplary communication notification recipient of a plurality of communication notification recipients, to communication notifications received from a plurality of communication originators, according to one or more embodiments;

FIG. 7B is a graphical representation depicting variations in the strength of adjacency relationships between contacts of the exemplary recipient of FIG. 7A and contacts of various communication originators;

FIG. 8A is a message flow diagram depicting the treatment, by an intended recipient of an invitation to establish a voice communication session (or “call”) with a communication originator, based on receipt of an enhanced notification including a passively derived classification of the communication originator, according to one or more embodiments;

FIG. 8B is a message flow diagram depicting the treatment, by a management agent of a unified communication server acting on behalf of an intended recipient of an invitation to establish a voice call with a communication originator, based on a passively derived classification of the communication originator; and

FIG. 9 s a detailed block diagram of a computer system, according to one or more embodiments.

While the method and apparatus is described herein by way of example for several embodiments and illustrative drawings, those skilled in the art will recognize that the method and apparatus for aiding in the administration of communication notifications associated with requests to establish a communication session and/or with the arrival or availability of e-mail, voice mail, and/or text messages is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for aiding in the management of communication notifications associated with requests to establish a communication session and/or with the arrival or availability of e-mail, voice mail, and/or text messages defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention include a system and method for administering arriving communication notifications and the communication session initiation (e.g., “call set up”) invitations or messages available for access/retrieval associated with those notifications. Some exemplary embodiments consistent with the claimed invention perform an automated filtering process by which those communication originators having a classification score below a threshold are assigned a low priority classification and/or those communication originators having a classification threshold above the threshold are assigned a high priority classification. In embodiments, a notification, invitation and/or a message (e.g., voice mail, e-mail, or text) received from a communication originator having a low priority classification may be rejected or deleted without alerting the intended recipient, it may be rescheduled for later delivery, or it may be forwarded as part of or in addition to an enhanced notification in order to alert the intended recipient as to the classification of the originator or to facilitate automatic enforcement of filtering rules by the intended recipient's communication terminal. The passively derived classification may include an identity of the originator, a role or employer of the originator, a functional classification of the originator, and/or a high vs. low priority descriptor.

In some embodiments, content of communication notifications or the message associated with those notifications are extracted at a server in order to identify each communication originator. For an SMS text message, a real-time voice call, or a “voice mail” message, the telephone number or other network address associated with the communication originator may be extracted and stored. In some cases, supplemental information such, for example, as “Caller ID” data may be available but in other cases it may unavailable. For e-mail, the sender's address is extracted from the e-mail envelope.

Over time, as the number of service subscribers and/or provisioned system users contacted by a particular communication originator increases, treatment statistics are accumulated for each communication originator and eventually reach statistical significance with respect to at least some of the communication originators. In some embodiments, when that number of contacted users reaches statistical significance and periodically thereafter, the treatment statistics are analyzed to passively determine a classification of the communication originator. In some embodiments, that “passively crowd-sourced” classification may be used in the processing of notifications and/or communications by a server and/or a communication terminal without regard to whether the intended recipient of a communication has previously received a communication from the communication originator. A passively derived classification derived by statistical analysis can be further adjusted, or one can be obtained independently, by evaluating the strength of any adjacencies between contacts of an intended recipient and contacts of the communication originator.

Current voice communication applications, voice mail and email applications, and chat applications hosted at a server or executing as a client application on a recipient's communication terminal neither track dynamically changing patterns in the treatment of communication originators (or even categories of communication originators) by the recipients, nor do they provide any suggestion of what action might be taken on the recipient's behalf, when certain patterns or changes in patterns are detected. A lack of effective techniques and systems for dealing with such problems as the volume of arriving voice calls and/or notifications of e-mail, voice mail and/or chat message availability can be distracting to the intended recipient and/or disruptive to his or her business activities, result in less efficient usage of voice, email and voice-mail as a business tool. Even during those times when an intended recipient can spare the time to review each notification and/or message, a classification passively derived according to embodiments of the present disclosure can enable the recipient to efficiently and quickly assess the opportunity cost of accepting or rejecting a call, or of deleting an e-mail, voice-mail, or text message without reading it allows the intended recipient to focus on more important priorities.

Various embodiments of systems and methods for administering arriving communications and/or notifications originated by various entities are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference will now be made in detail to exemplary embodiments of the present invention, examples of which are illustrated in the accompanying drawings. Wherever possible, the same reference numbers will be used throughout the drawings to refer to the same or like parts

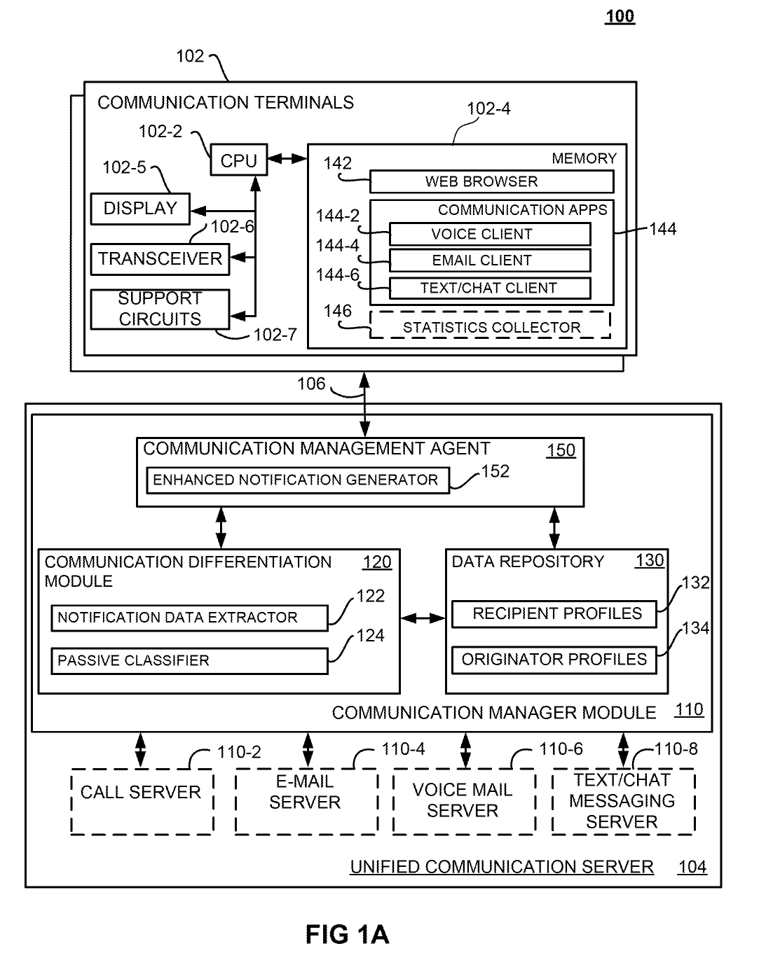

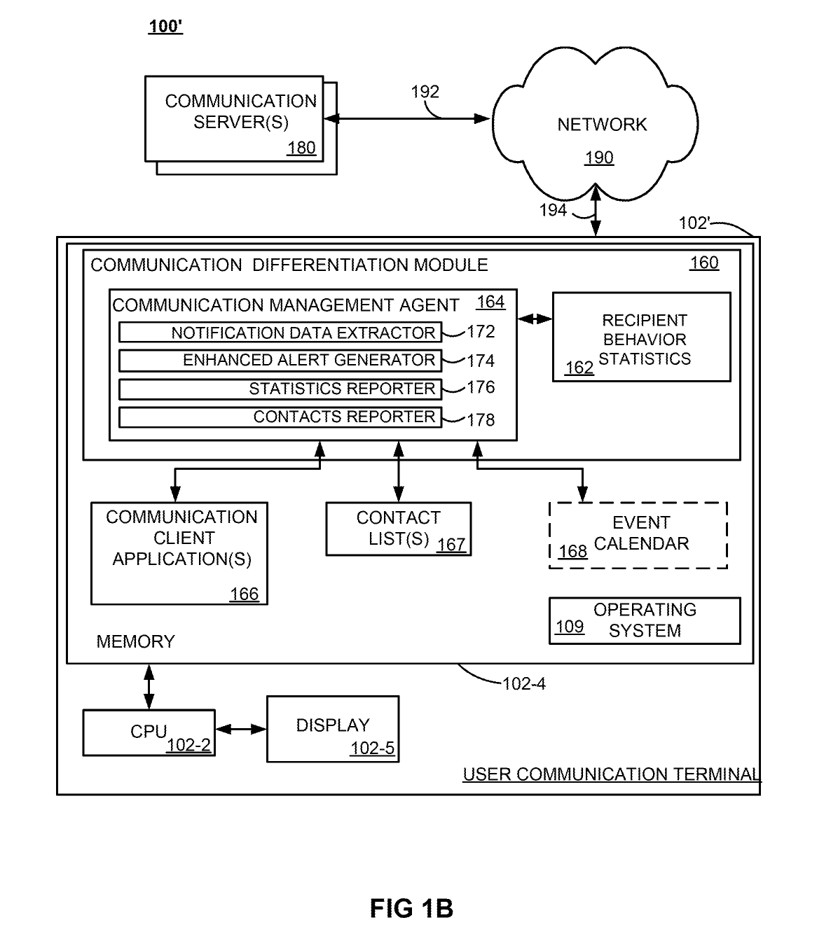

FIG. 1A is a block diagram depicting a communication system 100 configured to aid the intended recipients of communication notifications and associated invitations and/or messages in the management of voice calls, e-mail, voice-mail, and even SMS and/or chat text messages through detection and analysis of call treatment activity and/or activity patterns across multiple users of communication terminals, according to one or more network centric embodiments.

According to some embodiments, system 100 includes a plurality of communication terminals 102 and a unified communication server 104 configured to exchange communication signals over a network communication link 106. The unified communication server 104 includes a communication manager (CM) module 110 which includes a communication differentiation module (or “CDM”) 120 and a data repository 130. CDM 120 includes a notification data extractor 122 and a passive classifier 124, the operation of which will be described in great detail by reference to FIG. 1C. Data repository 130 containing user/subscriber preferences, contact list entries, and/or communication treatment statistics 132 (“recipient profiles”), as well as originator profiles 134 which may include an identity of each communication originator, if available, as well as a classification or classification score passively derived from recipient profile data in a manner which will be described shortly. In some embodiments, priority metrics for determining the classification are automatically derived, for a communication originator, from the treatment statistics of a plurality of users who have interacted with (or chosen not to interact with) that originator.

In addition, or by way of alternative, a priority metric for determining the classification according to some embodiments consistent with the present disclosure is obtained by determining the degree of separation (“strength of adjacencies”) between entries in the contact list of each communication originator and each provisioned recipient/user supported by system 100. By way of example, if a communication originator is among the contact entries stored in the profile of a supported user, that originator is deemed to have zero degrees of separation. If the communication originator and supported user share at least one contact entry in common, they are deemed to have one degree of separation. If originator and supported user have no contact entries in common, but one of the contact entries of each share an entry in common, they are deemed to have two degrees of separation, and so on.

In any event, and with continued reference to FIG. 1A, the recipient profiles 132 stored in data repository 130 include the recipient profile of a user who operates communication terminal 102. Communication terminal 102 includes at least one processor (CPU), as processor 102-2, and a memory indicated generally at 102-4. CPU 102-2 is operative to execute one or more applications which reside in memory 102-4. In the exemplary embodiment of FIG. 1A, the applications include a web browser 142 and/or one or more communication client applications 144 such as a voice client 144-2, e-mail client 144-4, and/or text/chat client 144-6. In embodiments where statistics are collected and reported by the communication terminal, a statistics collector 146 also resides in memory 102-4 of communication terminal 102 and is executable by CPU 102-2. The communication terminal 102 further comprises a display device 102-5, and transmission and receiving devices (or “transceiver”) 102-6. and support circuits 102-7. In some embodiments display terminal 102 is a mobile terminal and the transceiver 102-6 comprise one or more wireless transceivers compliant with corresponding wireless transmission protocol(s) such as IEEE 802.11, IEEE 802.13, Bluetooth, and/or cellular transmission protocols such as CDMA, TDMA, and/or GSM. However, it will be readily appreciated that communication link(s) 106 may utilize any conventional communication medium or media and is therefore not limited to a wireless medium.

Returning to the unified communication server 104 shown in FIG. 1A, it will be seen that CM module 110 further includes a communication management agent 150. In some embodiments, the communication agent 150 includes an enhanced notification generator 152 which generates an notification for transmission to a communication terminal as communication terminal 102. As used herein, an “enhanced notification” is one which conveys a passively derived classification of the communication originator which may include a priority level classification, a category descriptor applicable to the priority level classification, and/or an indication of an identity of the communication originator derived from the recipient profile of another supported user. As an example of the latter form of classification, a first user may have a contact list entry associated with the communication originator and several telephone numbers and/or e-mail addresses associated with that contact list entry. By reference to all known network addresses associated with a communication originator, a larger sample set is obtained which, in turn, increases the statistical significance of any classification passively derived according to embodiments of the present disclosure. Moreover, reference to these other known addresses can provide an identification of the originator which is missing from the received communication notification or an associated message.

In unified communications embodiments, system 100 further includes one or more communication exchange servers including a voice call server 110-2 utilizing, for example, a session initiation protocol (SIP) server, an email messaging server 110-4, a voice mail server 110-6 and an instant messaging server and/or SMS text messaging server 110-8. To facilitate retrieval of voice mail messages via e-mail server 110-4 and e-mail messages via voice mail server 110-6, corresponding speech-to-text and text-to-speech processors (not shown) may be provided.

FIG. 1B is a block diagram depicting a communication system 100′ configured to aid in the administration of communication notifications associated with requests to establish a communication session and/or with the arrival or availability of e-mail, voice mail, and/or text messages, according to one or more communication terminal (e.g., “endpoint”) centric embodiments of the present disclosure. The arrangement of and interrelationships between the various functional components of the embodiment of FIG. 1B are very similar to those of the embodiment of FIG. 1A. A principal difference between the respective embodiments is that in the former case, monitoring of communication originator treatment patterns and/or statistics across multiple communication recipients, as well as enforcement of processing rules specified in a recipient profile, are both performed by communication manager module 110 at a central server. In the illustrative embodiment of FIG. 1 B, on the other hand, at least some of the communication manager module's behavior/activity data statistics collection and/or pattern and usage monitoring functions are performed locally at a user communication terminal as communication terminal 102′.

In an embodiment, system 100′ includes a communication terminal 102′ having a central processing unit (CPU) 102-2′, a memory 102-4′, and a display 102-5′. Memory 102-4′ contains an operating system 109 and applications executable by CPU 102-2′. One of the applications residing in memory 102-4′ is a local communication differentiation module 160 which contains a recipient behavior statistics store 162 and a communication management agent 164. Communication management agent 164 includes a notification data extractor 172, an enhanced alert generator 174, statistics reporter 176, and a contacts reporter 178. Notification data extractor 172 contains instructions which, when executed by CPU 102-2′, process an incoming communication notification by extracting any information present in an enhanced notification received from one or more remote call and/or messaging (communication) servers 180 via network 190 and associated communication links 192 and 194. As previously discussed in connection with FIG. 1A, an enhanced notification conveys a passively derived classification of the communication originator, which may include a priority level classification, a category descriptor applicable to the priority level classification, and/or an indication of an identity of the communication originator derived from the recipient profile of one or more other supported users.

Each of the user communication terminals or devices as terminal 102 in FIG. 1A or 102′ in FIG. 1B is a computing device, for example a desktop computer, laptop, tablet computer, Smartphone, or the like that includes or is connected to a display and user input devices such as a mouse, keyboard, touch screen, camera, microphone, etc.

According to rules previously specified by the operator of communication terminal 102′ or by default on installation, a passively derived classification corresponding to a low priority level and/or a spam or solicitation category descriptor may be enforced in a number of ways designed to reduce and/or avoid distractions or disruptions. In embodiments consistent with both FIGS. 1A and 1B, such rules may be enforced by automatically terminating a call without generating an audible alert or visually displaying a message arrival/availability or transmitting call set up request to the operator of communication terminal 102′. Alternatively, while system 100′ is still gathering statistics in furtherance of forming an initial classification, the system may present such an alert communicating an unclassified status to the user.

In some embodiments consistent with FIG. 1 B, at least some of the rules are enforced by enhanced alert generator 174 such that audible alerts are provided where a classification is available and/or corresponds to a certain category descriptor (such, for example, as a likely personal call or likely call from a customer), while they are suppressed when the classification is unavailable and/or does not correspond to a high priority category descriptor. In still other embodiments, a rule specified by the communication terminal (or by default on installation) may require that alerting be presented regardless of the identity or classification of the communication originator. However, in such embodiments, a different audible tone corresponding to a low priority category descriptor may be generated.

To facilitate centralized collection and analysis of treatment statistics and assessment of contact list adjacencies, statistics reporter 176 retrieves data from recipient statistics store 162 and transmitting the same to a remote server such as one or more of servers 180. Also communicatively coupled to the communication management agent 164 of local communication differentiation module 160 are one or more communication client application(s) 166, contact list(s) 167, and optionally, an event calendar application 168. In some embodiments, contacts reporter 178 retrieves contact list entries from contact lists such, for example, as those associated with a e-mail client, a voice call client, or the like. Where the operator of communication terminal desires differential alert generation according, for example, to a meeting schedule, enhanced alert generator 175 may be configured to suppress audible e-mail, text, or voice mail arrival alerts and/or reject calls by reference to the event calendar 168.

Some embodiments of FIGS. 1A and 1B require the adoption and enforcement of a set of rules which, after a period of monitoring how a plurality of recipients have interacted (or refused to interact) with respective communication originators to determine a priority, category and/or adjacency classification, are proposed to and/or adopted by the user. According to some embodiments, a communication manager agent(s) associated with a server and/or communication terminal(s) may be programmed to:
inspect the caller id number and/or caller identifier field of each received call, gathering/deriving statistics, for each number or network address associated with a calling party. The statistics may include, but are not limited to:
   (i) the average duration (ACD) of each call received from and outgoing call made to the number/address, which requires logging the date, start time, and end time of each call;
   (ii) the ratio between the number of times a recipient of calls from the number/address terminated the call and the number of times the party placing the call from that number/address to the recipient terminated the call;
   (iii) the ratio between the number of inbound calls made from the number/address and the number of outgoing calls made to the number/address;
   (iv) the answer/reject ratio (ASR) for the number/address;
   (v) the ratio between SMS text messages received +calls received from the number/address and text messages sent to the number/address;
inspect the sender field of each email envelope over time, gathering/deriving frequency statistics, which may include but are not limited to:
   (i) a ratio between the number of times a particular e-mail address sends email to a recipient and the number of times e-mails are sent to that e-mail address;
   (ii) the average time delay between delivery of a notification of arrival of an e-mail message from a particular e-mail address (or corresponding phone number if a speech-to-text message) and accessing of the e-mail message by the recipient;
   (iii) the average time delay between accessing an e-mail message from a particular e-mail address and sending a response to the e-mail address;
   (iv) the ratio between the number of times an e-mail message from the e-mail address is accessed by the recipient and the number of times it is deleted without accessing it;
inspect each voice mail envelope over time, gathering frequency statistics, which may include but are not limited to:
   (i) a ratio between the number of times a particular caller leaves a voice mail message for a recipient and the number of times a call and/or e-mail is sent in reply to that number within a time interval short enough to be considered a return call;
   (ii) the average time delay between delivery of a notification of arrival of a voice-mail message from a particular calling number or address (or corresponding e-mail address if a text-to-speech message) and accessing of the voice mail message by the recipient;
   (iii) the average time delay between accessing a voice mail message from a particular number/network address and placing a call to the e-mail address; and
   (iv) the ratio between the number of times a voice mail message from the e-mail address is accessed by the recipient and the number of times it is deleted without accessing it.

In addition to, or an alternative to the above statistics, another useful metric for assessing the probability that a particular caller or e-mail sender is likely to have a high priority classification warranting reviewing an arrival notification, accepting a call, and/or accessing a voice or e-mail message, is the strength of adjacencies between contacts of the communication originator and those of the intended recipient. In some embodiments, a high classification status is automatically given for any communication originator having at least one zero degree (already in the recipient's contact list) or a one degree adjacency (a contact shared by both contact lists), or a threshold is established by assigning decreasing weights to each adjacency from the zero degree to the nth degree and these are summed to arrive at a numeric value against a statistically derived threshold. Still other ways of assessing the strength of contact adjacencies is to take into account the percentage of zero to three degree or four degree contacts of a recipient that include the communication originator as a contact list entry.

A communication originator who has a zero degree adjacency with ten percent or more of the contacts in a recipient's contact list, a one degree adjacency with twenty percent or more of the contacts in a recipient's contact list, and/or a two degree adjacency with forty percent or more of the contacts in a recipient's contact list may be deemed, in some embodiments, to be a personal call of the intended recipient and therefore exempt from processing according to analysis of the accumulated treatment statistics. Conversely, as the number of degrees of separation between the contact list of the originator and intended recipient grows, the adjacency strength falls sharply such that the existence of six or seven degree adjacency relationships offers no insight into the significance of the originator to the intended recipient. Moreover, just as entries in a contact list can be used to assess the strength of a particular relationship between, for example, a caller and a called party, so to can entries in a “call block” list. Thus, for example, if communication system 100 (FIG. 1A) or system 100′ (FIG. 1B) were to implement call blocking based on entries in a recipient profile, then the call blocking decisions of an intended recipient's contact list may be used to passively classify the caller.

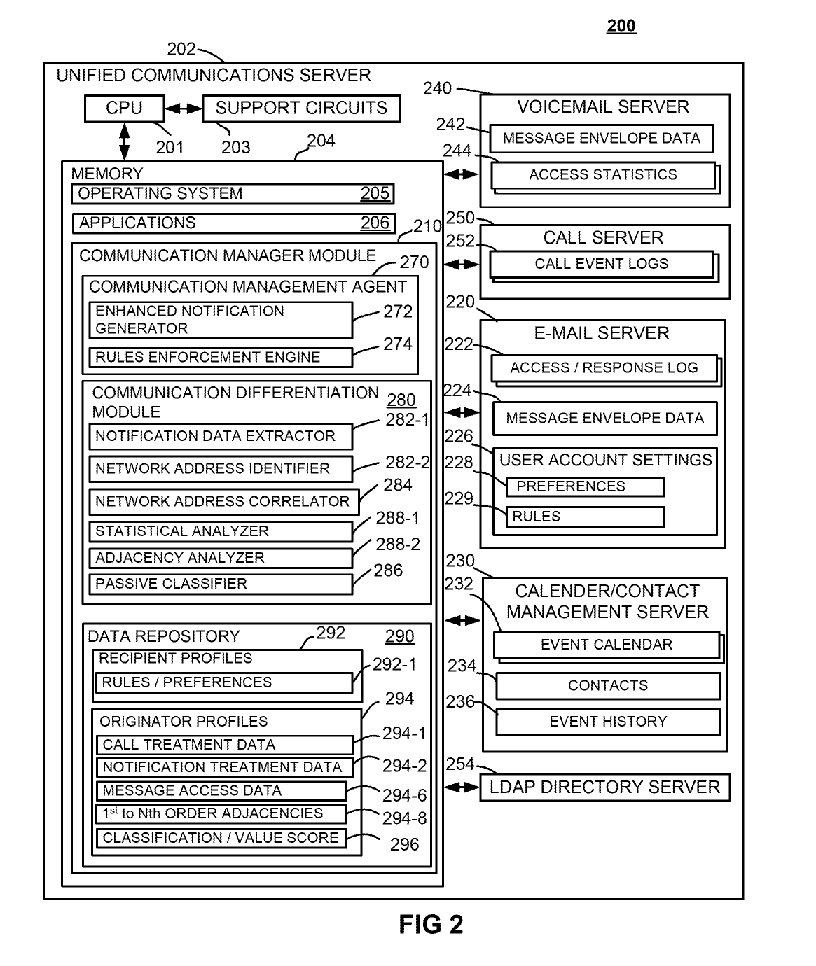

FIG. 2 is a block diagram depicting, in greater detail, the interaction between the functional components in a system 200 according to embodiments exemplified by FIG. 1A. The various components of system 200 include unified communication server 202, email server 220, calendar/contact management server 230, voicemail messaging server 240, call server 250, and an LDAP directory server 254. Server 202 is coupled to a plurality of communication terminals (not shown) via suitable communication links. Some of the links are established by a network which includes a communication system that connects computers (or devices) by wire, cable, fiber optic and/or wireless link facilitated by various types of well-known network elements, such as hubs, switches, routers, and the like. The network interconnecting some components may also be part of the Intranet using various communications infrastructure, such as Ethernet, Wi-Fi, a personal area network (PAN), a wireless PAN, Bluetooth, Near field communication, and the like.

The various servers 202, 220, 230, 240, 250 and 254, are each a computing device, or may be the same computing device as, for example, a desktop computer, laptop, tablet computer, and the like, or they may be cloud based servers e.g., a blade server, virtual machine, and the like. For each provisioned calendar/contact management services user or subscriber, calendar/contact management server 230 provides services to a calendar application on the user terminals as communication terminal 102 of FIG. 1A. For example, calendar server 230 provides to communication terminal 102 an event calendar 232, including schedule information, directory services (“Contacts”) 234, event history 236, and email services. Likewise, for each provisioned voice mail user or subscriber, voice mail server 240 maintains a voice mail message queue, message envelope data 242 indicating an identification of the caller or caller's extension (if available), and a date and time when a voice mail message was left for the user. In embodiments consistent with the present disclosure, the voice mail server 240 further includes an access/response log 244 which records the date and time when the user first accessed the voice mail and, if applicable, whether and when a voice mail message was forwarded to another extension (a voice message forwarded to another party qualifying as a “response” according to one or more embodiments). As noted previously, server 202 may further include a speech-to-text interface (not shown) operative to convert voice messages into email messages.

For each provisioned telephony services user or subscriber, call server 250 maintains call event logs 252 The call event logs include an incoming call log indicating a date and time when a call for the user was received, an identification of the caller's identity, phone number or extension (if available), and an indication of whether and when (date/time) each call was answered by the user or forwarded to voice mail message or to another extension (with answering or forwarding a call received from an email sender each qualifying as a “response” to an email message received from the sender if performed subsequent to receiving and reading the email message, according to some embodiments), and an indication of a date and time when the user first accessed the voice mail. By way of illustrative example, a speech to text converter (not shown) associated with unified communication system 202 may be configured to search transcribed content of the dialog between a caller and call recipient to identify the presence of any key words in the call also present in the received email.

The call event logs 252 further include an outgoing call log indicating a date and time when a call by the user was made, an identification of a number of the number dialed, and an indication of the duration of the call. According to one or more embodiments, a call log entry indicating that the user called the sender of an email qualifies as a “response” to an email message received from the sender if performed subsequent to receiving and reading the email message. As already mentioned, speech to text converter (not shown) associated with unified communication system 202 may be configured to search transcribed content of the dialog between a caller and call recipient to identify the presence of any key words or names in the call also present in the received email. According to one or more embodiments, LDAP directory server 254 provides caller and call recipient directory lookups as needed to support the aforementioned response classifications.

For each provisioned email user or subscriber, email server 220 maintains an email message queue 222 and message envelope information 224 identifying the sender's email address, recipient's email address, the date and time of delivery to an email inbox, and user account settings 226 including rules and preferences 228 and rules 229 defined by the user. Such rules are enforceable by the email server 220 and are typically designed to reduce the amount of email which must be stored on the server pending user review and to separately treat spam or other undesirable email so that the limited time the user may have to review his or her email is effectively utilized. Although not shown in FIG. 2, voice mail server 240 may be configured with similar user account settings, including rules and preferences, for dealing with low or no priority voice mail messages differently from higher priority messages (i.e., by deleting them unread without notifying the intended recipient associated with the voicemail box).

According to some embodiments, unified communication server 202 includes a communication manager module 210 comprising a set of instructions residing in memory 204 and executable by a Central Processing Unit (CPU) 201. The CPU 201 may include one or more commercially available microprocessors or microcontrollers that facilitate data processing and storage. Various support circuits 203 facilitate the operation of the CPU 201 and include one or more clock circuits, power supplies, cache, input/output circuits, and the like. The memory 204 includes at least one of Read Only Memory (ROM), Random Access Memory (RAM), disk drive storage, optical storage, removable storage and/or the like.

In addition to communication manager module 210, memory 204 includes an operating system 205, and a plurality of applications 206 including the aforementioned optional speech-to-text converter. Communication manager module 210 includes a communication management agent 270, a communication differentiation module 280, and a data repository 290. Communication management agent 270 includes an enhanced notification generator 272 which generates prompts and/or classification/category descriptor alerts to be sent or presented to the users of communication terminals as communication terminal 102 (FIG. 1A). Communication management agent 270 further includes a rules enforcement engine 274 for generating notifications to be sent or presented to call server 250, email server 220 and/or voicemail server 240 to accommodate enforcement of one or more rules or preferences 292-1 adopted by the user and utilizing a passively derived classification supplied by communication differentiation module 280.

Communication differentiation module 280 a notification data extractor 282-1, identifier 282-2, a network address correlator 284, a statistical analyzer 288-1, an adjacency analyzer 288-2, and a passive classifier 286. In some embodiments, network address identifier is operative, through instructions executed by CPU 201, to monitor the flow of incoming calls, voice mail messages, and email messages. For voice calls processed according to the SIP protocol, for example, a call set up request which identifies the party requesting the establishment of a communication session and the party or parties with whom the session is to be established is received at a server. Rather than merely forwarding a request to a communication terminal operated by the intended recipient, however, embodiments consistent with the present disclosure subject the request to additional processing.

In an embodiment, notification data extractor 282-1 extracts the network address (e.g., a phone number, e-mail address, and/or internet protocol address) and, if available, the identity of a party who is presently requesting a voice communication session or has sent an e-mail, voice mail, or text message is determined by network address identifier 282-2. In the latter cases, voice mail server 240 and e-mail server 220 are configured to transmit a notification to communication management agent 270, rather than directly to the recipient.

The extracted address or identity is passed to rules enforcement engine 274, which determines whether or not an existing classification or category descriptor exists for that address or entity. If a pre-existing classification or category descriptor does exist for the communication originator, then rules enforcement engine processes the notification and/or associated communication according to rules and/or preferences 292-1 specified by the intended recipient and stored in a recipient profile 292.

If no pre-existing classification exists for the extracted network address or identity, the network address correlator 284 determines whether the extracted network address and/or identity are associated with any other address specified in a contact list entry stored in a recipient profile 292 within data repository 290. If so, then the correlated address(es) or identity is passed to rules enforcement engine 274, which determines whether or not an existing classification or category descriptor exists for the correlated address or entity. If a pre-existing classification or category descriptor does exist for the communication originator, then rules enforcement engine processes the notification and/or associated communication according to rules and/or preferences 292-1 specified by the intended recipient and stored in a recipient profile 292.

If no existing classification is yet available for the extracted address or identity and any correlated addresses, then one may be derived by passive classifier 286 based on analysis performed by one or both of statistical analyzer 288-1 and adjacency analyzer 288-2. For each network address (e-mail address, phone number, IP address, etc) previously processed by system 200, a corresponding communication originator profile 294 is stored in data repository 290. In an embodiment, each originator profile 294 comprises call treatment data 294-1, notification treatment data 294-2, message access data 294-6, 1st to nth order adjacencies 294-8, and a classification 296 including a classification value score (numeric or letter grade “A” to “F”), a priority rating (e.g., “high”, “low” or “unknown”) and/or a category descriptor (e.g., “personal contact”, “probable business contact” or “spam”).

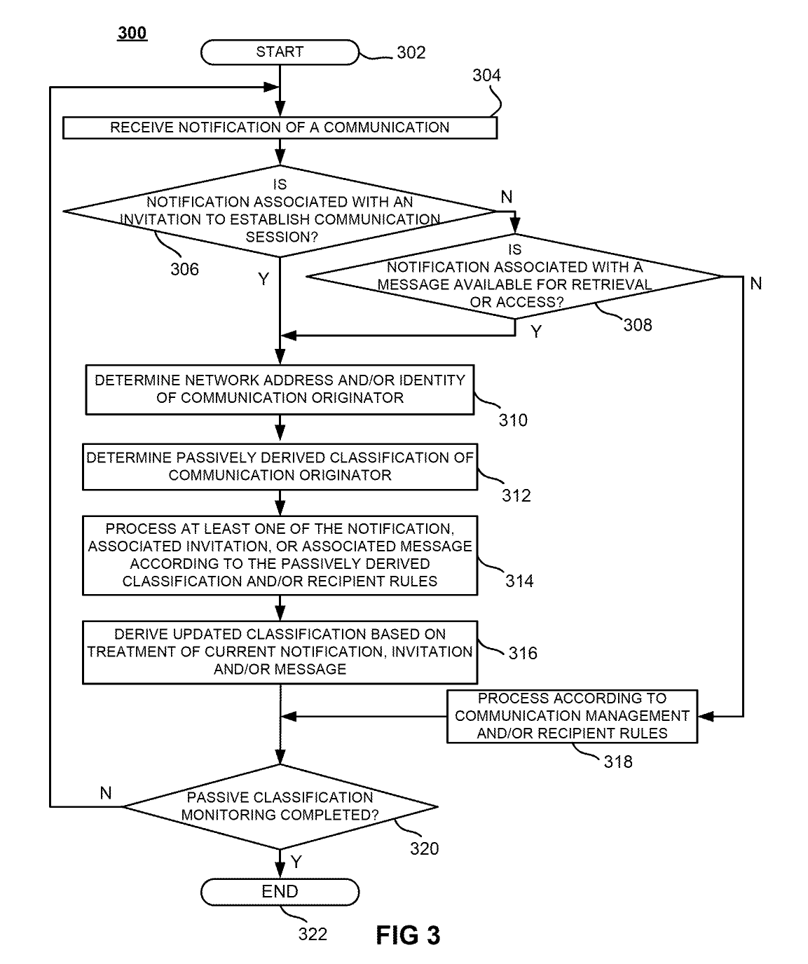

FIG. 3 is a flow diagram depicting a method 300 for aiding recipients in the administration of communication notifications, according to one or more embodiments. The method 300 starts at 302 and proceeds to 304. At 304, a communication notification is received and associated with the arrival of an invitation to establish a communication session with a communication originator (e.g., a “caller”), or to the arrival of an e-mail, SMS text message, or a voice mail, from the communication originator, which is available for viewing, accessing and/or retrieval. The method 300 proceeds to 306 where a determination is made as to whether the notification is associated with an invitation to establish a communication session. If so, the method proceeds to 310. If not, a second determination is made at 308 as to whether the notification is associated with a message available for viewing, retrieval or access by the operator of a communication terminal. If so, the method also proceeds to 310.

At 310, a determination is made as to a network address and/or identity of the originator of an invitation and/or message with which the communication notification is associated. The method then proceeds to 312 where a classification of the originator is retrieved or passively derived. From 312, the method 300 proceeds to 314 where at least one of the notification or the associated call or message is processed according to the passively derived classification and/or any automated treatment rules established by or on behalf of the recipient. From 314, the method 300 proceeds to 316, where an updated classification for the communication originator is passively determined based on how the current notification, associated invitation, or associated message was treated by the recipient.

From 316, the method 300 proceeds to 320, where a determination is made as to whether passive classification based processing should continue or terminate. If it is to continue, the method 300 returns to 304 and the process resumes when the next communication notification arrives. If passive classification is not to continue, method 300 proceeds to 322 and terminates. If, at 308, a determination is made that a received communication or notification does not pertain to a supported mode of communication, then the method also proceeds to 318 and is processed according to communication management and/or recipient rules. The method 300 proceeds to 320 and processing occurs as described above.

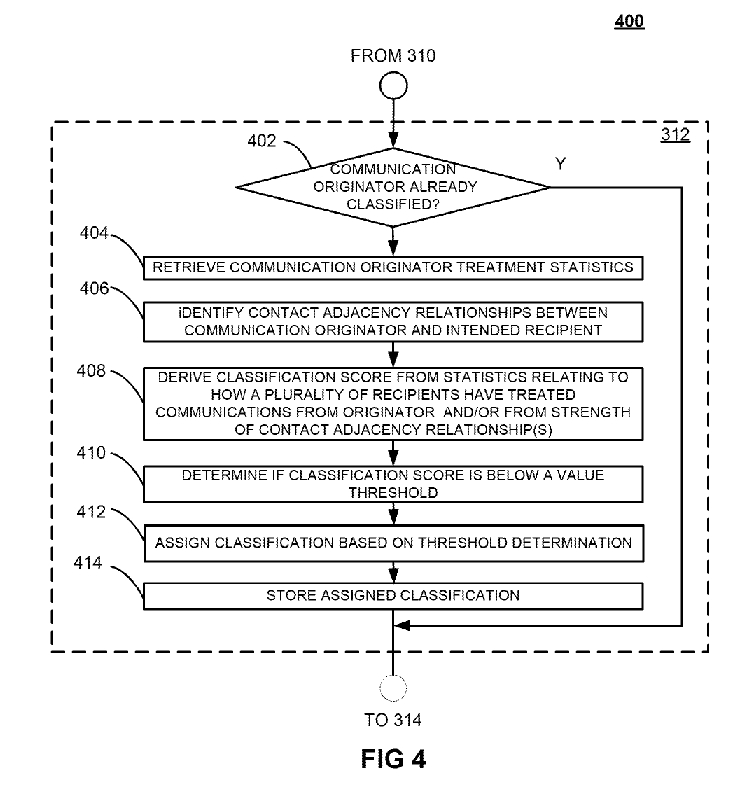

FIG. 4 is a flow diagram depicting a method 400 for determining a passively derived classification of a communication originator as, for example, a sub-process of the method 300 of FIG. 3, according to one or more embodiments. Method 400 is entered, from 310 of method 300, at 402, where a determination is made as to whether a communication originator is already classified. If so, the method 400 returns to method 300 at 314. Otherwise, the method proceeds to 404, where communication originator treatment statistics are retrieved. From 404, the method 400 proceeds to 406, where contact adjacency relationships between the originator and intended recipient are identified and evaluated. The method then proceeds to 408.

At 408, a classification score is derived from the statistics retrieved at 404 and/or the strength and degree of adjacency relationships determined at 406. The method 400 then proceeds to 410, where a determination is made as to whether the classification value is above or below a threshold. At 412, a classification such as a priority level or category descriptor is assigned based on the threshold determination at 410, and at 414, the classification is stored for subsequent use at the next execution of 402. From 414, the process returns to method 300 at 314.

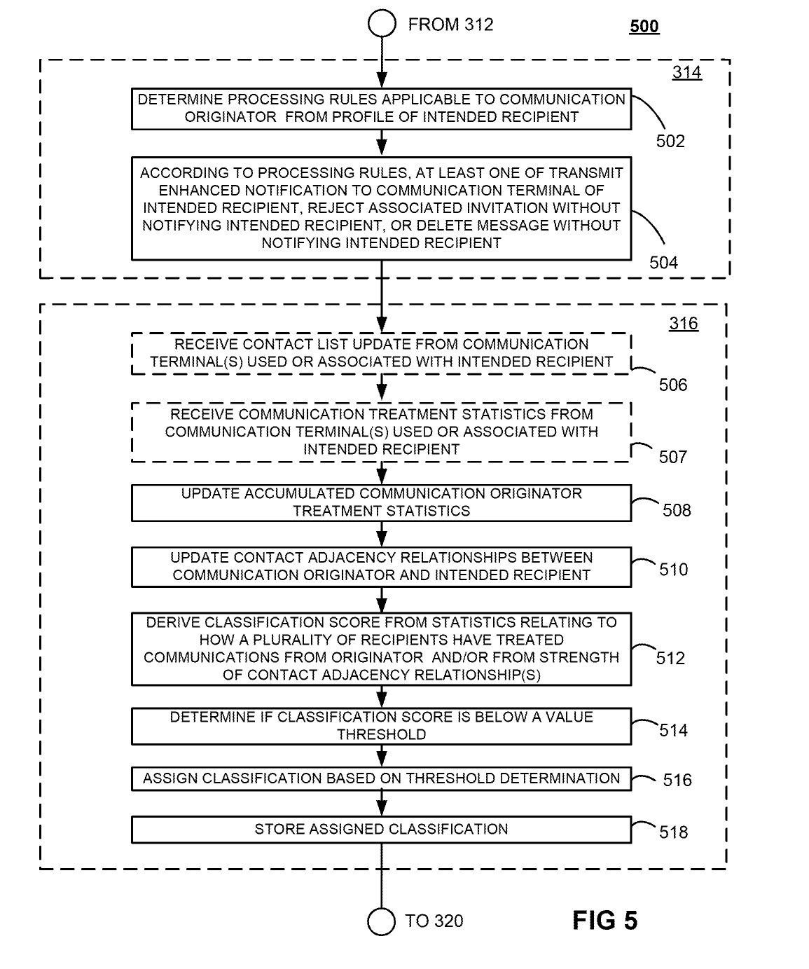

FIG. 5 is a flow diagram depicting a network centric method 500 for processing, based on the passively derived classification, a communication notification and/or an arriving invitation or message availability notification associated with the notifications as, for example, a sub-process of the method of FIG. 3, according to one or more embodiments. The method 500 is entered from 312 of method 300, starting at 502. At 502, a determination is made as to which processing rules, if any, are applicable to notifications associated with calls or messages from the communication originator. From 502, the method 500 proceeds to 504. At 504, at least one or more of following is/are performed according to the applicable processing rules determined at 502: (i) transmit an enhanced notification to the intended recipient's communication terminal, (ii) reject a call set up invitation without notifying or alerting the intended recipient audibly and/or visually; and/or (iii) delete an associated e-mail, voice, or text message without notifying the intended recipient.

From 504, the method 500 proceeds to optional steps 506 and/or 507, or otherwise to 508. At 506, contact list updates are received from one or more communication terminal(s) used or associated with the intended recipient. At step 507, communication treatment statistics are received from one or more communication terminal(s) used or associated with the intended recipient. From any of 504, 506 or 507, method 500 proceeds to 508. At 508, the accumulated communication originator statistics are updated based on locally stored data and/or data uploaded from a plurality of communication terminals. From 508, the method 500 proceeds to 510.

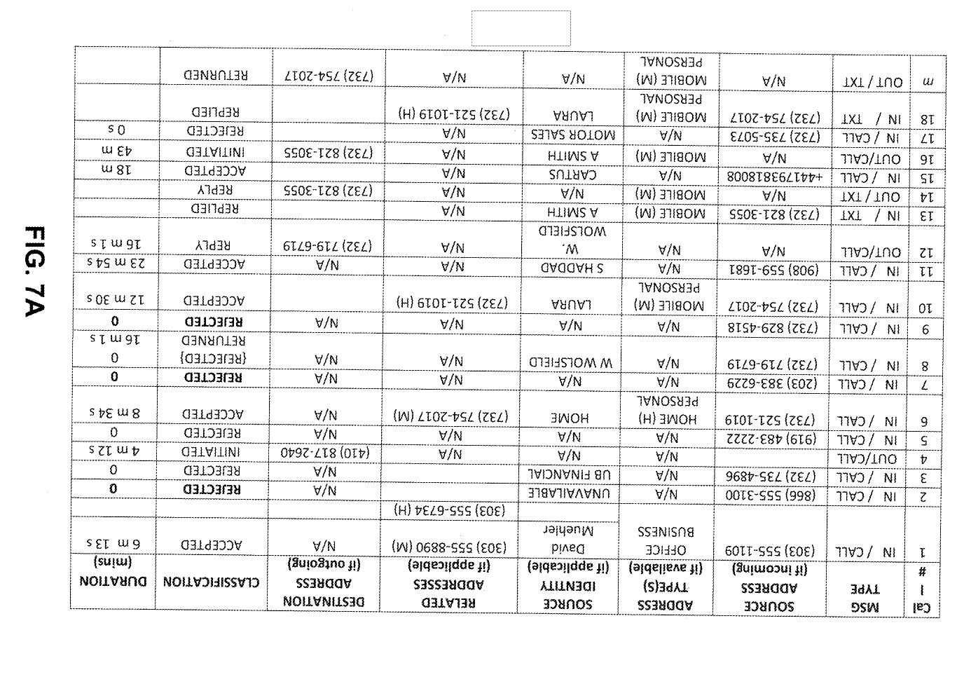

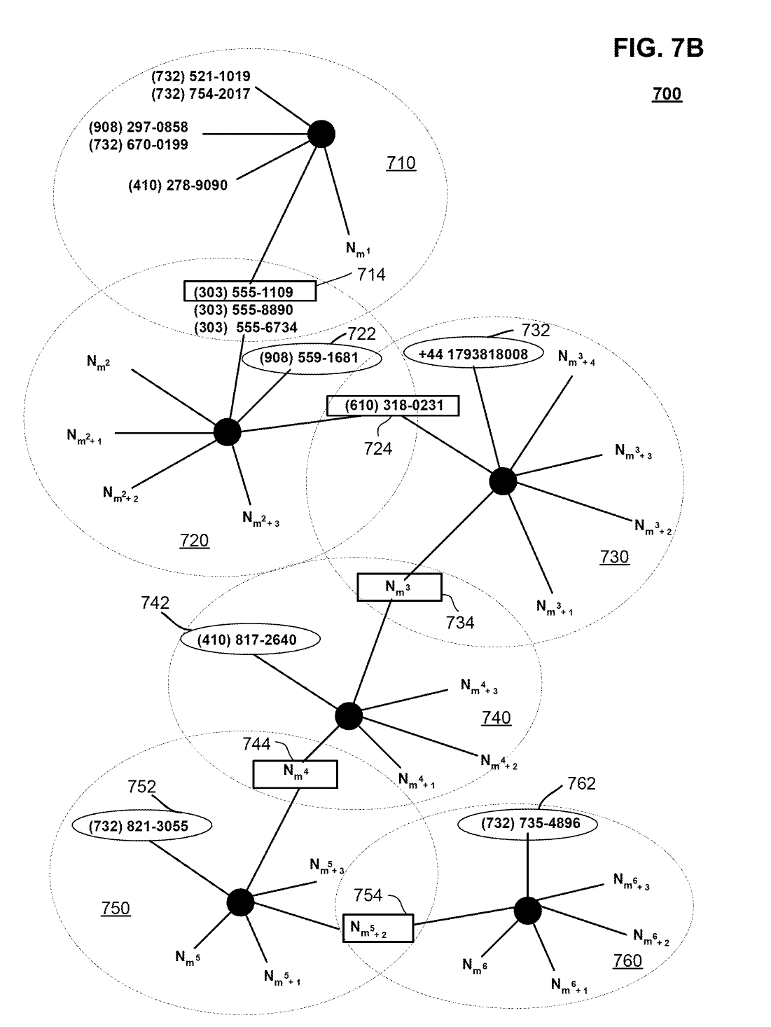

At 510, the degree of adjacency relationships between contact lists associated with respective communication originators and those associated with a plurality of communication recipients is computed, as is strength of at least some contact entries. From 510, the method 500 proceeds to 512, where a classification score is passively derived from the updated statistics and/or the adjacency degree and strength data. An exemplary method for computing the classification score is discussed in connection with FIGS. 7A and 7B below. From 512, the method 500 proceeds to 514.

At 514, a determination is made as to whether the classification score is below a given threshold and, at 516, a classification is assigned based on the classification score. At 518, the classification is stored for subsequent use in processing future calls from the same originator. The method 500 then returns to method 300 at step 320.

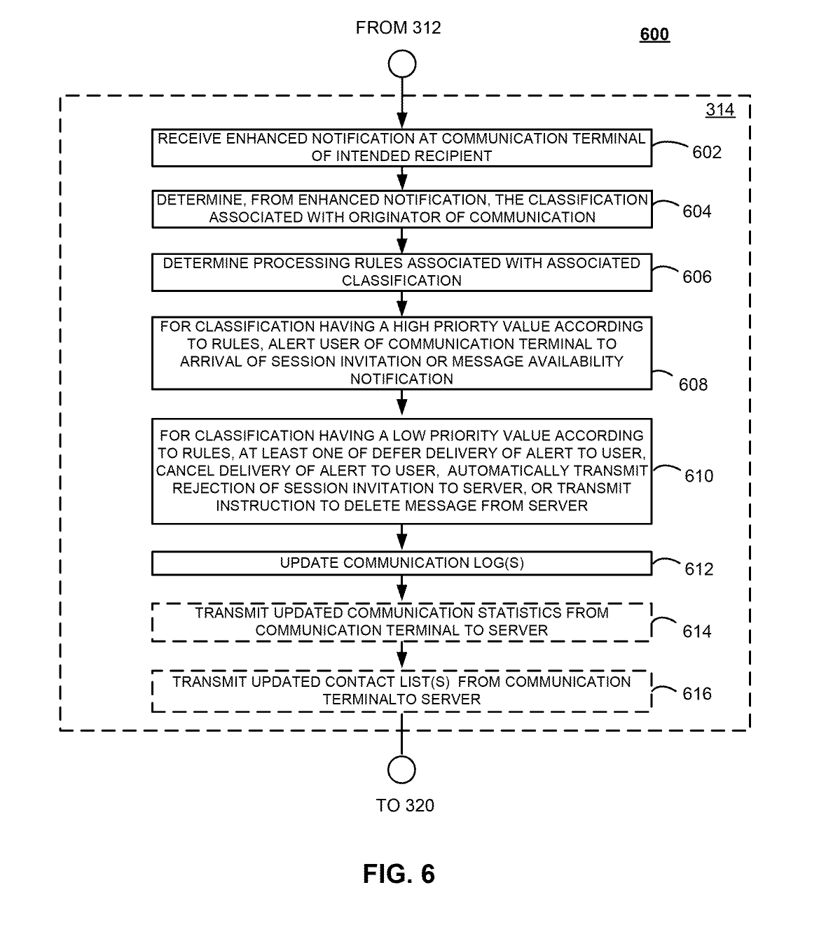

FIG. 6 is a flow diagram depicting a communication terminal centric method 600 for processing, based on the passively derived classification, a communication notification and/or an arriving invitation or message availability notification associated with the notifications as, for example, a sub-process of the method of FIG. 3, according to one or more embodiments.

The method 600 is entered at 602 from 312 of method 300. At 602, an enhanced notification is received at a communication terminal associated with an intended recipient. From the enhanced notification, the classification associated with the originator of an arriving voice mail invitation, e-mail message, voice-mail message, or text message is determined at 604. The method 600 then proceeds to 606. At 606, the processing rules associated with the classification are determined and the method then proceeds to 608.

At 608, a classification conveying a high priority value or category descriptor indicative of a high probability of being of immediate interest to the intended recipient is processed according to rules that give the notification appropriate visibility to the user. The rules may specify, for example, that the communication terminal generate an audible alert which enables the user of that terminal to readily ascertain the importance or likely importance of the originator. The method 600 then proceeds to 610.

At 610, a classification conveying a low priority value or category descriptor indicative of a low probability of being of immediate interest to the intended recipient is processed according to rules that avoid disturbing or distracting the intended recipient. The rules, when enforced by the processor of the communication terminal of the intended recipient, may, for example (i) defer delivery of an alert or associated message to the intended recipient, (ii) cancel delivery of an alert or associated message to the intended recipient, (iii) automatically transmit rejection of a session invitation to a server or, in a peer-to-peer arrangement, directly to the originator or (iv), transmit an instruction to delete a message from a server. The method 600 proceeds from 610 to 612.

At 612, communication log(s) stored at the intended recipient communication terminal are stored. At this point, method 600 may return to method 300 at 320, or it may proceed to optional step 614, wherein updated communication statistics derived from the communication logs are transmitted to a server, and/or to optional step 616, where contact list addition or deletion are reported to the server. When aggregated with updates received from a number of other communication terminal users, the data can be used to derive updated classifications.

FIG. 7A is a tabular representation depicting the treatment given, by an exemplary communication notification recipient of a plurality of communication notification recipients, to communication notifications received from a plurality of communication originators, according to one or more embodiments. Over time, such statistics are gathered for at least some of these communication originators, across all users of a system, as system 100 of FIG. 1A or system 200 of FIG. 2, who have received a voice call, an e-mail message, a voice mail, and/or an SMS text message. From these statistics, such metrics as the average call duration, the answer/reject ratio, the ratio of recipient disconnected calls to originator disconnected calls, the ratio of incoming and outgoing calls involving the originator's number, and others as described above, are computed and used to passively derive a classification of the communication originators.

As noted previously, a classification passively derived according to embodiments consistent with the present disclosure may be enhanced or alternatively based on the strength of contact list adjacencies. FIG. 7B is a graphical representation depicting variations in adjacency relationships between contacts of the exemplary recipient of FIG. 7A and contacts of various communication originators. The adjacency graph 700 depicts the relationship(s) between the contact lists of six users of communication terminals, the contact list of the intended recipient being indicated generally at reference numeral 710 and the contact list of the communication originator (e.g. a caller) being indicated generally at reference numeral 760. Contact list 720 refers to a 0th degree contact (an adjacency value of zero), meaning that a number or e-mail address, indicated at 714, appears in the contact list of the intended recipient. Since the number (908) 559-1681, indicated by reference numeral 722, is an entry in contact list 720, that number is a 1st degree contact (adjacency value, adj=1).

Likewise, contact list 720 and contact list 730 share a contact entry (610) 318-0231 and therefore the user associated with contact list 730 is a 2nd degree contact of the intended recipient. As such, the international number +44 1793818008 has an adjacency value adj=2. Contact list 730 and contact list 740 share a contact entry Nₘ_{³} indicated at 734 and therefore the user associated with contact list 740 is a 3rd degree contact of the intended recipient. As such, the number (410) 817-2640 has an adjacency value adj=3. Contact list 740 and contact list 750 share a contact entry Nₘ_{⁴} indicated at 744 and therefore the user associated with contact list 750 is a 4th degree contact of the intended recipient. As such, the number (732) 821-3055 has an adjacency value adj=4. Finally, in this example, contact list 750 and the contact list 760 associated with the originator share a contact entry Nₘ_{⁵} indicated at 754 and therefore the user associated with contact list 760 is a 5th degree contact of the intended recipient. Accordingly, the number (732) 735-4896 has an adjacency value adj=5.

In an embodiment, information such as that exemplified in FIGS. 7A and 7B is passively derived according to a classification value equation:

V_{c}=(a^{adj}×str^{adj})^{1/b}

where a and b are constants, 0<a<1 and b>1, adj is an integer corresponding to the degree of separation between contact list entries of the communication originator and intended recipient, and str is the adjacency strength as determined by the number of times the originator's number appears in a contact list a recipient's contacts. The function diminishes close to zero very quickly as the degree of adjacency increases, and the result can never be greater than unity (the b root forces higher values to approach 1 faster, but has little effect on lower values). As such, the classification value obtained will be between zero and one and the higher it is, the more likely it is that the number or address of a communication originator belongs to a person of interest to the intended recipient.

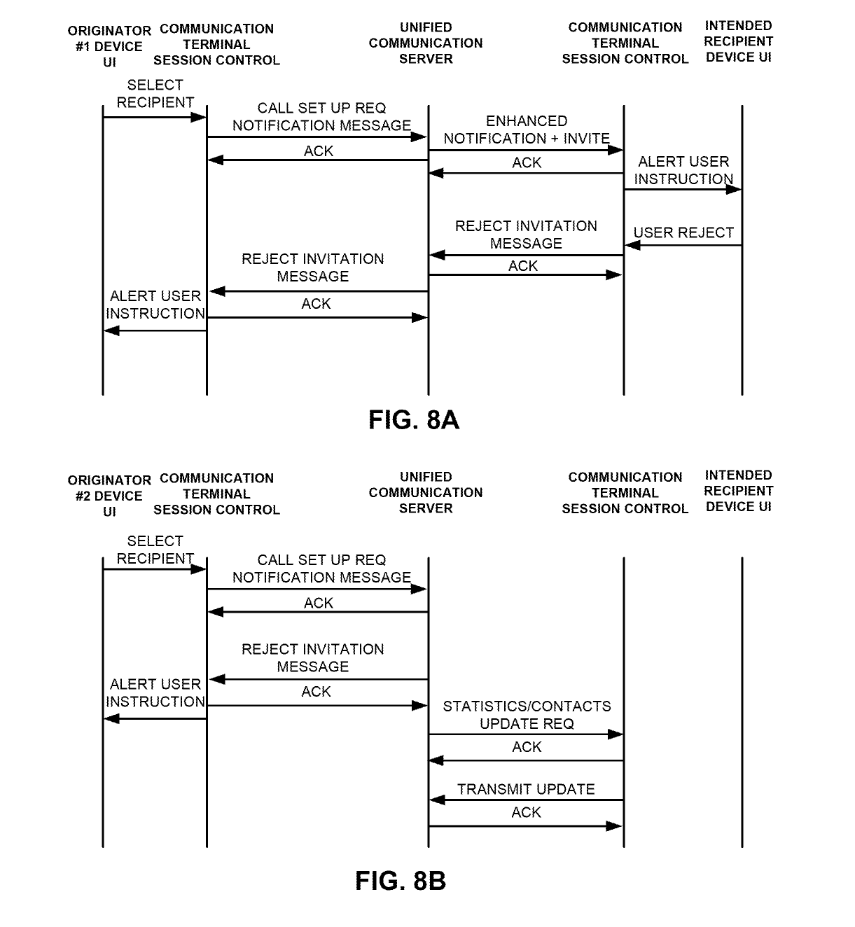

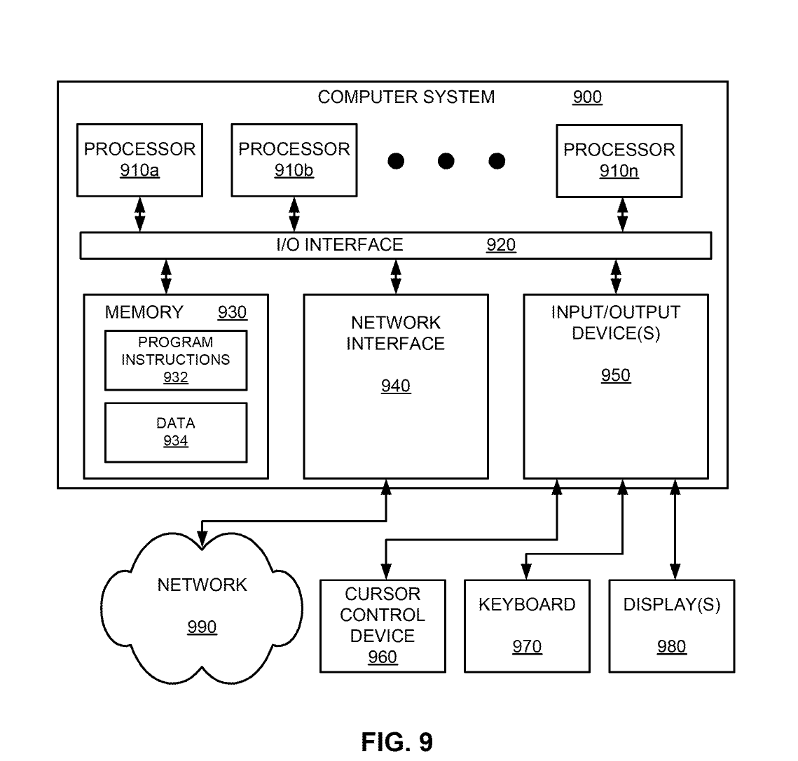

FIG. 8A is a message flow diagram depicting the treatment, by an intended recipient of an invitation to establish a voice communication session (or “call”) with a communication originator, based on receipt of an enhanced notification including a passively derived classification of the communication originator, according to one or more embodiments. In this example, a communication originator utilizes the user interface of a communication terminal such a desktop VoIP phone or smart phone, or a voice client application of a smart phone, to place a call to an intended recipient. A call set up request is transmitted from the communication terminal to a server, and that request is acknowledged. The request serves as a communication identification, and identifies both the caller's number and the called party's number. However, before forwarding a call set up request (“invitation”) to the intended recipient, the server determines if a classification applies to the caller and, if so, an enhanced notification is transmitted that includes, for example, a category descriptor for the caller as well as the invitation to accept a call.

When received the enhanced notification is processed by the recipient's communication terminal, which in some embodiments results in an audible and/or visual presentation of the category descriptor to the intended recipient. In this case, the recipient utilizes the user interface of the communication terminal to reject the invitation, which rejection is transmitted back to the originator's device and acknowledged.

FIG. 8B is a message flow diagram depicting the treatment, by a management agent of a unified communication server acting on behalf of an intended recipient of an invitation to establish a voice call with a communication originator, based on a passively derived classification of the communication originator. In this case, according to rules enforceable by the server, the classification associated with the originator operating device #2 calls for rejection of the invitation without disturbing the intended recipient. As such, the call setup request is acknowledged and, thereafter, responded to directly by the server via a subsequent rejection message. As part of ongoing collection of statistics, the server may periodically request that the communication terminal(s) associated with the intended recipient upload recently collected treatment statistics and/or additions to the contact list(s) locally stored at the device. To this end, a communication terminal session control function executed at the terminal responds to an update request by first acknowledging, and then transmitting any requested update(s). In alternative embodiments, the updates are uploaded at regular intervals rather than as a response to an update request.

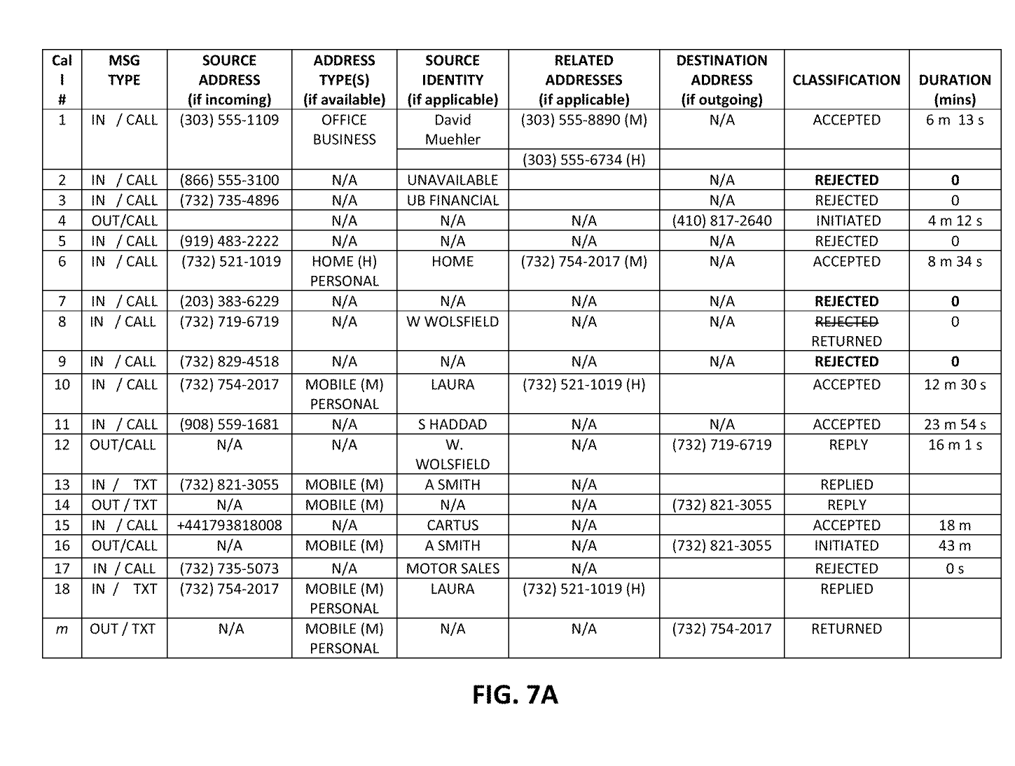

FIG. 9 s a detailed block diagram of a computer system, according to one or more embodiments. Various embodiments of method and apparatus for organizing, displaying and accessing contacts in a contact list, as described herein, may be executed on one or more computer systems, which may interact with various other devices. One such computer system is computer system 900 illustrated by FIG. 9, which may in various embodiments implement any of the elements or functionality illustrated in FIGS. 1-8B. In various embodiments, computer system 900 may be configured to implement methods described above. The computer system 900 may be used to implement any other system, device, element, functionality or method of the above-described embodiments. In the illustrated embodiments, computer system 900 may be configured to implement method 300 (FIG. 3), method 400 (FIG. 4), method 500 (FIG. 5), method 600 (FIG. 6), and/or the message flows depicted in FIGS. 8A and 8B as processor-executable executable program instructions 932 (e.g., program instructions executable by processor(s) 910) in various embodiments.

In the illustrated embodiment, computer system 900 includes one or more processors 910a-910n coupled to a system memory 920 via an input/output (I/O) interface 930. Computer system 900 further includes a network interface 940 coupled to I/O interface 930, and one or more input/output devices 950, such as cursor control device 960, keyboard 970, and display(s) 980. In various embodiments, any of the components may be utilized by the system to receive user input described above. In various embodiments, a user interface may be generated and displayed on display 980. In some cases, it is contemplated that embodiments may be implemented using a single instance of computer system 900, while in other embodiments multiple such systems, or multiple nodes making up computer system 900, may be configured to host different portions or instances of various embodiments. For example, in one embodiment some elements may be implemented via one or more nodes of computer system 900 that are distinct from those nodes implementing other elements. In another example, multiple nodes may implement computer system 900 in a distributed manner.

In different embodiments, computer system 900 may be any of various types of devices, including, but not limited to, a personal computer system, desktop computer, laptop, notebook, or netbook computer, mainframe computer system, handheld computer, workstation, network computer, a set top box, a mobile device such as a smart phone or PDA, a consumer device, video game console, handheld video game device, application server, storage device, a peripheral device such as a switch, modem, router, or in general any type of computing or electronic device.

In various embodiments, computer system 900 may be a uniprocessor system including one processor 910, or a multiprocessor system including several processors 910a to 910n (e.g., two, four, eight, or another suitable number). Processors 910 may be any suitable processor capable of executing instructions. For example, in various embodiments processors 910 may be general-purpose or embedded processors implementing any of a variety of instruction set architectures (ISAs). In multiprocessor systems, each of processors 910 may commonly, but not necessarily, implement the same ISA.

System memory 930 may be configured to store program instructions 932 and/or data 932 accessible by processor 910. In various embodiments, system memory 930 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 930. In other embodiments, program instructions and/or data may be received, sent or stored upon different types of computer-accessible media or on similar media separate from system memory 930 or computer system 900.

In one embodiment, I/O interface 920 may be configured to coordinate I/O traffic between processor 910, system memory 930, and any peripheral devices in the device, including network interface 940 or other peripheral interfaces, such as input/output devices 950. In some embodiments, I/O interface 920 may perform any necessary protocol, timing or other data transformations to convert data signals from one component (e.g., system memory 930) into a format suitable for use by another component (e.g., processor 910). In some embodiments, I/O interface 920 may include support for devices attached through various types of peripheral buses, such as a variant of the Peripheral Component Interconnect (PCI) bus standard or the Universal Serial Bus (USB) standard, for example. In some embodiments, the function of I/O interface 920 may be split into two or more separate components, such as a north bridge and a south bridge, for example. Also, in some embodiments some or all of the functionality of I/O interface 920, such as an interface to system memory 920, may be incorporated directly into processor 910.

Network interface 940 may be configured to allow data to be exchanged between computer system 900 and other devices attached to a network (e.g., network 990), such as one or more display devices (not shown), or one or more external systems or between nodes of computer system 900. In various embodiments, network 990 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 940 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 950 may, in some embodiments, include one or more display terminals, keyboards, keypads, touchpads, scanning devices, voice or optical recognition devices, or any other devices suitable for entering or accessing data by one or more computer systems 900. Multiple input/output devices 950 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 940.

In some embodiments, the illustrated computer system may implement any of the methods described above, such as the methods illustrated by the flowcharts of FIGS. 3-6. In other embodiments, different elements and data may be included.

Those skilled in the art will appreciate that computer system 900 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 900 may be transmitted to computer system 900 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method, comprising:
receiving at a first device, over a communication medium, a notification associated with at least one of an invitation to establish a communication session between a second device associated with a communication originator and the first device associated with an intended recipient, or a message from the second device associated with the communication originator available for at least one of retrieval or access by the intended recipient via the first device; and
processing, at the first device, at least one of the notification, an associated invitation, or an associated message based on a passively derived classification of the communication originator,
wherein the passively derived classification is derived based on at least a determined degree of adjacency between the communication originator and at least one contact stored in a contact directory associated with the intended recipient.

2. The method of claim 1, wherein the passively derived classification is further derived by;
analyzing prior interactions between the communication originator and at least some of a plurality of communication terminal user.

3. The method of claim 1, wherein the processing includes automatically blocking, on behalf of the intended recipient, initiation of a communication session between the communication originator and the intended recipient.

4. The method of claim 3, wherein the receiving and the processing are performed at a server.

5. The method of claim 3, wherein the processing includes forwarding, to a communication terminal operated by the intended recipient, an enhanced notification comprising an invitation to establish a communication session with the communication originator.

6. The method of claim 5, wherein the enhanced notification includes the passively derived classification.

7. The method of claim 5, wherein the enhanced notification includes at least one of an identity, an association, or a characteristic of the communication originator.

8. The method of claim 2, further including classifying the communication originator based on prior interactions between the communication originator and at least some of a plurality of communication terminal users.

9. The method of claim 8, wherein the classifying comprises:
determining, for each of a plurality of communication terminals respectively operated by a corresponding user of a plurality of users, at least one of:
a quantity of times a corresponding user at least one of extended or accepted an invitation to establish a communication session with the communication originator;
a quantity of times a corresponding user rejected an invitation to establish a communication session with the communication originator; or
a duration of each communication session established between a corresponding user and the communication originator.

10. The method of claim 8, wherein the classifying comprises:
determining, for each of a plurality of communication terminals respectively operated by a corresponding user of a plurality of users:
at least one of a quantity of incoming text messages, a quantity of incoming voicemail messages, or a quantity of incoming e-mail messages a corresponding user received from the communication originator; and
at least one of a quantity of outgoing text messages, a quantity of outgoing voicemail messages, or a quantity of outgoing e-mail messages a corresponding user sent to the communication originator.

11. The method of claim 10, wherein the classifying further comprises:
determining, for each of a plurality of communication terminals respectively operated by the corresponding user of a plurality of users:
at least one of a quantity of unaccessed incoming text messages, a quantity of unaccessed incoming voicemail messages, or a quantity of unaccessed incoming e-mail messages a corresponding user received from the communication originator and deleted by the corresponding user; or
at least one of a quantity of unaccessed outgoing text messages, a quantity of unaccessed outgoing voicemail messages, or a quantity of unaccessed outgoing e-mail messages sent by a corresponding user and deleted by the communication originator.

12. The method of claim 1, wherein the receiving and the processing are performed at a communication terminal operated by the intended recipient.

13. The method of claim 12, wherein the processing includes presenting at least one of a visible or an audible alert to the intended recipient, wherein the visible or audible alert comprises at least one of the passively derived classification, an identity, an association, or a characteristic of the communication originator.

14. The method of claim 12, wherein the notification is received from a server and includes the passively derived classification.

15. The method of claim 14, further including storing, in a memory of the communication terminal, statistics comprising at least one of:
a quantity of times the communication terminal was operated to at least one of extend or accept an invitation to establish a communication session with the communication originator;
a quantity of times the communication terminal was operated to reject an invitation to establish a communication session with the communication originator; or
a duration of each communication session established between a user of the communication terminal and the communication originator.

16. The method of claim 15, further includes at least one of transmitting the statistics stored in memory to the server for remote derivation of the passively derived classification or transmitting, to a server, for an enhanced notification conveying the passively derived classification.

17. An apparatus comprising:
a computer having one or more processors, memory and at least one network interface, and further comprising:
a transceiver that receives, over a communication medium, a notification associated with at least one of an invitation to establish a communication session between a first device associated with a communication originator and second device associated with an intended recipient, or a message from the first device associated with the communication originator available for at least one of retrieval or access by the second device associated with the intended recipient,
wherein the memory stores instructions executable by the one or more processors to process at least one of the notification, an associated invitation, or an associated message based on a passively derived classification of the communication originator, and
wherein the passively derived classification is derived based on at least a determined degree of adjacency between the communication originator and at least one contact stored in a contact directory associated with the intended recipient.

18. The apparatus of claim 17, wherein the instructions are further executable to at least one of (a) reschedule delivery of an alert to a communication terminal associated with the intended recipient, (b) cancel delivery of an alert to a communication terminal associated with the intended recipient, (c) reject the invitation or message associated with the received notification, or (d) generate and forward an enhanced notification to a communication terminal associated with the intended recipient, based on a passively derived classification of the communication originator.

19. The apparatus of claim 17, wherein the instructions stored in the memory are executable by the processor to derive the passively derived classification by at least one of:
analyzing prior interactions between the communication originator and at least some of a plurality of communication terminal users; or
determining adjacencies between the communication originator and at least one contact stored in a contact directory associated with the intended recipient.

20. The apparatus of claim 19, wherein the instructions are further executable for determining, for each of a plurality of communication terminals respectively operated by a corresponding user of a plurality of users, at least one of:
a quantity of times a corresponding user at least one of extended or accepted an invitation to establish a communication session with the communication originator;
a quantity of times a corresponding user rejected an invitation to establish a communication session with the communication originator; or
a duration of each communication session established between a corresponding user and the communication originator.

21. The apparatus of claim 19, wherein the instructions are further executable for determining, for each of a plurality of communication terminals respectively operated by the plurality of communication terminal users, at least one of:
a quantity of times a corresponding user at least one of extended or accepted an invitation to establish a communication session with the communication originator;
a quantity of times a corresponding user rejected an invitation to establish a communication session with the communication originator; or
a duration of each communication session established between a corresponding user and the communication originator.

22. The apparatus of claim 19, wherein the instructions are further executable for determining, for each of a plurality of communication terminals respectively operated by the plurality of communication terminal users:
at least one of a quantity of incoming text messages, a quantity of incoming voicemail messages, or a quantity of incoming e-mail messages a corresponding user received from the communication originator; and
at least one of a quantity of outgoing text messages, a quantity of outgoing voicemail messages, or a quantity of outgoing e-mail messages a corresponding user sent to the communication originator.

23. A non-transitory computer readable storage medium for storing executable code that, when executed by a processor, causes the processor to perform a method, the method comprising:
receiving, over a communication medium, a notification associated with at least one of an invitation to establish a communication session between a communication originator and an intended recipient, or a message from the communication originator available for at least one of retrieval or access by the intended recipient; and
processing at least one of the notification, an associated invitation, or an associated message based on a passively derived classification of the communication originator,
wherein the passively derived classification is derived based on at least a determined degree of adjacency between the communication originator and at least one contact stored in a contact directory associated with the intended recipient.

24. The computer readable storage medium of claim 23, where processing at least one of the notification, an associated invitation, or an associated message based on a passively derived classification of the communication originator includes at least one of (a) rescheduling delivery of an alert to a communication terminal associated with the intended recipient, (b) canceling delivery of an alert to a communication terminal associated with the intended recipient, (c) rejecting the invitation or message associated with the received notification, or (d) generating and forward an enhanced notification to a communication terminal associated with the intended recipient, based on a passively derived classification of the communication originator.
